(19) United States
(12) Patent Application Publication
(10) Pub. No.: US 2016/0221302 A1
(43) Pub. Date: Aug. 4, 2016

(54) CONFIGURABLE COMPOSITES

(71) Applicant: President and Fellows of Harvard College, Cambridge, MA (US)

(72) Inventors: Alok Suryavamsee TAYI, Somerville, MA (US); Ju-Hee SO, Cambridge, MA (US); Frank WITTBRACHT, Borgholzhausen (DE); Rui M.D. NUNES, Somerville, MA (US); Robert F. SHEPHERD, Brooktondale, NY (US); George M. WHITESIDES, Newton, MA (US)

(21) Appl. No.: 15/026,331

(22) PCT Filed: Oct. 2, 2014
(86) PCT No.: PCT/US2014/058739

§ 371 Date: Mar. 31, 2016

Related U.S. Application Data
(60) Provisional application No. 61/886,210, filed on Oct. 3, 2013.

(51) Int. Cl. B32B 7/04; B32B 3/10; B32B 5/26; B32B 1/02

(52) U.S. Cl. CPC B32B 7/045; B32B 1/02; B32B 3/10; B32B 5/26; B32B 2260/023; B32B 2260/046

(57) ABSTRACT

Composite materials that are configurable, their preparation, and their uses are described. A composite article includes a plurality of sheets positioned to interleave and partially overlap with each other and held together by interactions between the plurality of sheets and a compressive force across the plurality of sheets, wherein each of the plurality of sheets is infused with an elastomer and forms at least one smooth surface, wherein each of the plurality of sheets is in close contact with adjacent ones of the plurality of sheets, wherein an overlapping area of the plurality of sheets provides resistance to a shear force applied to the composite article.

### RELATED APPLICATIONS

This application claims the benefit of the earlier filing date of U.S. Patent Application No. 61/886,210, filed on Oct. 3, 2013, the contents of which are incorporated by reference herein in its entirety.

### GOVERNMENT FUNDING CLAUSE

This invention was made with support from the United States government under Grant No. W911NF-09-1-0746 awarded by the US Army. The United States government has certain rights to this invention.

### TECHNICAL FIELD

The field of this application generally relates to composite materials, methods for forming them, and their uses.

### BACKGROUND

Conventional structural composites, such as rebar-reinforced concrete, laminated wood, and carbon fiber-reinforced composites, have static physical and mechanical properties (e.g., shape, strength, conformability, etc.). Such structures cannot be easily altered and, if damaged, are difficult to repair. Thus, it is sometimes advantageous to form a composite material that is configurable to fit customized needs.

### SUMMARY

Composite materials that are configurable, their preparation, and their uses are described.

Disclosed subject matter includes, in one aspect, a composite article, which includes a plurality of sheets positioned to interleave and partially overlap with each other and held together by interactions between the plurality of sheets and a compressive force across the plurality of sheets, wherein each of the plurality of sheets is infused with a plastic (e.g., an elastomer) and forms at least one smooth surface, wherein each of the plurality of sheets is in close contact with adjacent ones of the plurality of sheets, wherein an overlapping area of the plurality of sheets provides resistance to a shear force applied to the composite article.

In some embodiments, the plurality of sheets include fabric sheets.

In some embodiments, the plurality of sheets include at least one of carbon fabric sheets, metallic meshes, or papers.

In some embodiments, the elastomer contains polydimethylsiloxane (PDMS).

In some embodiments, the composite article also includes a deformable container enclosing the plurality of sheet, wherein the compressive force is generated by a pressure difference between the outside and inside of the deformable container.

In some embodiments, the deformable container is air tight.

In some embodiments, the compressive force is approximately 1 bar.

In some embodiments, the compressive force is generated by an electric field.

In some embodiments, the compressive force is generated by a magnetic field.

In some embodiments, the composite article also includes at least one end region coupled to an external coupling.

In some embodiments, the resistance to the shear force increases when the number of the plurality of sheets increases.

In some embodiments, the resistance to the shear force increases when the overlapping area increases.

In some embodiments, the at least one smooth surface has an average roughness Rₐ of about 200 nm.

Disclosed subject matter includes, in another aspect, a method of preparing a composite article, which includes providing a plurality of sheets, infusing each of the plurality of sheets with a plastic (e.g., an elastomer) to form at least one smooth surface, interleaving and partially overlapping the plurality of sheets with each other, and applying a compressive force across the plurality of sheets, wherein each of the plurality of sheets is in close contact with adjacent ones of the plurality of sheets and wherein an overlapping area of the plurality of sheets provides resistance to a shear force applied to the composite article.

In some embodiments, the method also includes providing a substrate with a second smooth surface, applying the elastomer on the second smooth surface of the substrate, placing each of the plurality of sheets onto the second smooth surface of the substrate, pressing the each of the plurality of sheets against the substrate to infuse the elastomer into the each of the plurality of sheets, curing the elastomer infused in the each of the plurality of sheets, and removing the each of the plurality of sheets from the substrate, wherein the at least one smooth surface is formed on the each of the plurality of the sheet.

In some embodiments, the plurality of sheets include fabric sheets.

In some embodiments, the plurality of sheets include at least one of carbon fabric sheets, metallic meshes, or papers.

In some embodiments, the elastomer contains polydimethylsiloxane (PDMS).

In some embodiments, the method also includes placing the plurality of sheets inside a deformable container, and lowering air pressure inside the deformable container, wherein the compressive force is generated by a pressure difference between the outside and inside of the deformable container.

In some embodiments, the compressive force is approximately 1 bar. The compressive force can be less than 1 bar and greater than 0 bar. In some examples, the compressive force is in the range of 640 mbar to about 1 bar.

In some embodiments, the compressive force is generated by an electric field.

In some embodiments, the compressive force is generated by a magnetic field.

In some embodiments, the method also includes increasing the number of the plurality of sheets to increase the resistance to the shear force.

In some embodiments, the method also includes increasing the overlapping area to increase the resistance to the shear force.

In some embodiments, the at least one smooth surface has an average roughness Rₐ of about 200 nm.

Disclosed subject matter includes, in yet another aspect, a composite article, which includes a first plurality of tiles at a first layer, and a second plurality of tiles at a second layer, positioned over the first layer, wherein each of the first and second plurality of tiles is infused with an elastomer and forms at least one smooth surface, wherein each of the second plurality of tiles at the second layer partially overlaps with and bridges at least two of the first plurality of tiles at the first layer, wherein the first and second plurality of tiles are held together by interactions among the first and second plurality of tiles and a compressive force across the first and second plurality of tiles and remain immobile to each other, wherein an overlapping area of the first and second plurality of tiles provides resistance to a shear force applied to the composite article.

In some embodiments, the first and second plurality of tiles become mobile to each other when the compressive force is relieved.

In some embodiments, the first and second plurality of tiles include fabric-based tiles.

Disclosed subject matter includes, in yet another aspect, a method of preparing a configurable composite article, which includes preparing a first plurality of tiles at a first layer, overlaying a second plurality of tiles at a second layer on top of the first layer, wherein each of the second plurality of tiles partially overlaps with and bridges at least two of the first plurality of tiles, applying a compressive force across the first and second pluralities of tiles so that the first and second pluralities of tiles are in close contact and immobile to each other, fitting the first and second pluralities of tiles to a profile of an object, relieving the compressive force so that the first and second pluralities of tiles become mobile to each other, rearranging the first and second pluralities of tiles to conform with the profile of the object, and applying a second compressive force across the first and second pluralities of tiles so that the first and second pluralities of fabric tiles are again in close contact and immobile to each other.

In some embodiments, the first and second plurality of tiles include fabric-based tiles.

### BRIEF DESCRIPTION OF THE DRAWINGS

The following figures are provided for the purpose of illustration only and are not intended to be limiting.

FIG. 1 illustrates a cross-section diagram of an exemplary configurable composite article;

FIG. 2 illustrates perspective diagrams of an exemplary configurable composite article in a deformable container;

FIG. 3 illustrates an exemplary process of preparing an exemplary configurable composite article;

FIG. 4 illustrates an exemplary process of preparing one sheet for constructing configurable composite articles;

FIG. 5 illustrates another exemplary process of preparing one sheet for constructing configurable composite articles;

FIG. 6 illustrates an exemplary testing process for a configurable composite article;

FIG. 7 illustrates mechanical properties of some exemplary configurable composite articles;

FIG. 8 illustrates a perspective view of another exemplary configurable composite article;

FIG. 9A illustrates a cross-section diagram of contact surfaces in the exemplary configurable composite article of FIG. 8;

FIG. 9B illustrates a top-view diagram of contact surfaces in the exemplary configurable composite article of FIG. 8; and

FIG. 10 illustrates an exemplary process of using the exemplary configurable composite article of FIG. 8.

### DETAILED DESCRIPTION

The patent and scientific literature referred to herein establishes knowledge that is available to those of skill in the art. The issued U.S. patents, allowed applications, published foreign applications, and references, that are cited herein are hereby incorporated by reference to the same extent as if each was specifically and individually indicated to be incorporated by reference.

For convenience, certain terms employed in the specification, examples and claims are collected here. Unless defined otherwise, all technical and scientific terms used in this disclosure have the same meanings as commonly understood by one of ordinary skill in the art to which this disclosure belongs. The initial definition provided for a group or term provided in this disclosure applies to that group or term throughout the present disclosure individually or as part of another group, unless otherwise indicated.

Composites that can be reconfigured into a load-bearing structure, on command, can enable the fast construction of temporary structures. The composites themselves can be transported as flat sheets; materials with a flat geometry can be easier and less expensive to transport than a pre-assembled structure since the composites can be stacked. Structures formed with these configurable composites can be customized for the circumstance.

In some embodiments, configurable composite articles, which are made of interleaved sheets and compressed together (e.g., using vacuum-jam, electric field, magnetic field, etc.), can hold large loads, can be fashioned into various shapes, and can be changed with varying internal pressures. If a load-bearing system were to break, the composite can be re-assembled and re-constructed by interleaving and vacuum-sealing in a fast and convenient manner. In some embodiments, load-bearing prostheses made of configurable composites can shape-shift into a load-bearing structure and do not need to be replaced periodically as patients age.

In one aspect of the disclosed subject matter, the physical and mechanical properties of the configurable composite articles can be configured to fit various needs. In one example, the number of interleaved sheets, the overlapping area of the interleaved sheets, the compressive force across the interleaved sheets, and/or the composition of the interleaved sheets can be adjusted to configure the configurable composite articles. In another example, properties of the individual sheets can also be altered to adjust the physical and mechanical properties (e.g., conductivity, optical transparency, chemical resistance, etc.) of the configurable composite article.

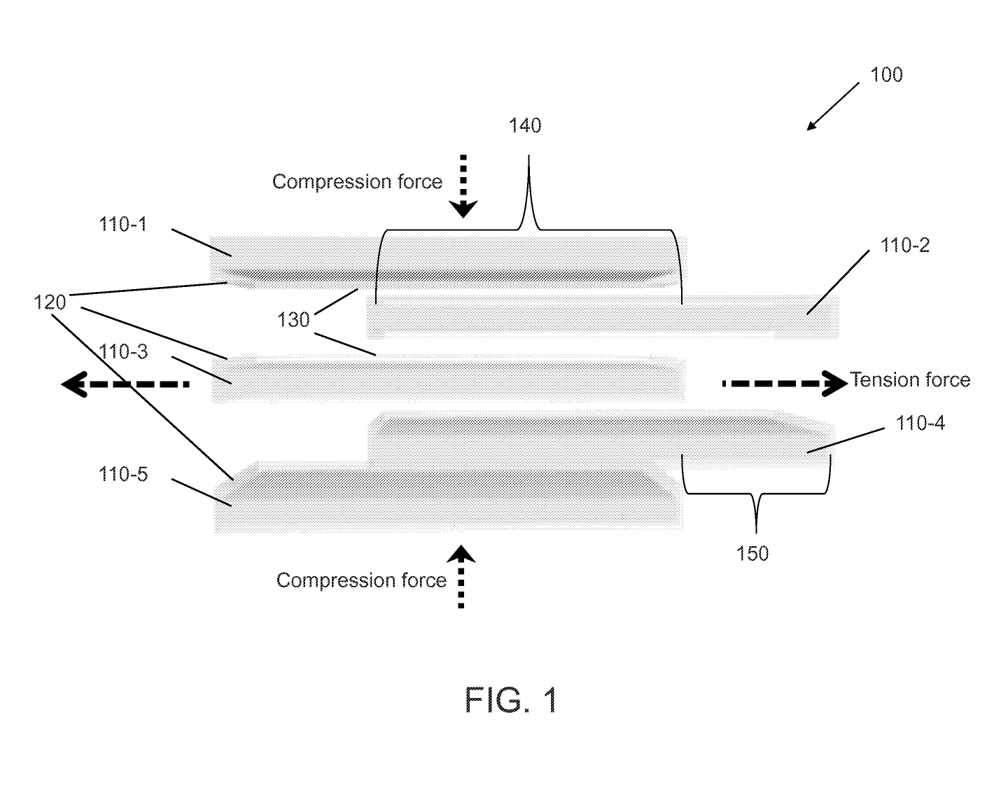

FIG. 1 contains a schematic cross-section diagram of an exemplary configurable composite article 100 according to some embodiments of the disclosed subject matter. The configurable composite article 100 can contain a plurality of sheets 110-1, 110-2, 110-3, 110-4, and 110-5. The reference number 110 in this document can be used to refer to the plurality of sheets collectively or a sheet individually. In some embodiments, the sheets 110 can be fabric sheets, which can be woven or non-woven. Fabrics that are flexible, scalable, and lightweight, can impart strength into the configurable composite article 100. The fabrics within the sheets can be capable of extension. The fabrics can be of many varieties, such as carbon fabrics, stretchable wool, stiff Kevlar, paper, polyethylene/paper blend, polyester fabric, glass fiber cloth, metallic meshes (e.g., aluminum or steel), etc.

Each of the plurality of sheets 110 can be infused with a material 120 to form a smooth surface 130 on the sheet 110. The material 120 can be in many forms, such as gels, thermoplastics, rigid plastics, and clays, etc. In some embodiments, the material 120 can be an elastomer 120. Examples of the elastomer include polydimethylsiloxane (PDMS) and urethane rubbers (e.g., ReoFlex), etc. In some embodiments, the sheets 110 can have a network-like quality that can be slightly porous. This can help the material 120 such as an elastomer to infuse the fabric sheet 110 more easily. The elasticity of the material 120 along with the extensibility of the fabrics can allow the composite article 100 to stretch. In addition, the elastomer 120 infused in the sheets 110 can help provide mechanical flexibility to the composite article 100.

The plurality of sheets 110 can interleave with each other. In some embodiments, the plurality of sheets do not completely overlap with each other. For example, sheets 110-1, 110-2, 110-3, 110-4, and 110-5 only partially overlap with each other and form an overlap area 140. A non-overlapping portion 150 of the sheets can be connected to an external coupling (e.g., a clamp). In some embodiments, a force can be exerted across the plurality of sheets to compress the plurality of sheets against each other. The smooth surfaces 130 can help ensure the sheets are in close contact with each other.

Close contact between elastomer-infused sheets can increase the effective contact surface area and thus increase the shear resistance of the configurable composites. More points of contacts can increase interactions between two adjacent sheets. Interactions can include covalent or non-covalent interactions. For example, urethanes that are partially cured can form covalent bonds between neighboring sheets over time. Examples of the non-covalent interactions include van der Waals forces, pi-pi stacking, hydrogen-bonding, charge-transfer, and electrostatics, etc. The elastomers can also be selected to have adhesive attraction to one another, to thereby increase the inherent shear resistance between adjacent layers. These inter-sheets interactions can provide resistance (e.g., friction) to sliding (e.g., shear force).

As discussed earlier, infusing sheets 110 with a material such as an elastomer 120 can help improve the smoothness of the surfaces 130, which increases surface contact area. Table 1 lists the average roughness Rₐ and its standard deviation for some exemplary surfaces.

TABLE 1
Average Roughness of some exemplary surfaces

| | Carbon | | CF infused | CF infused | CF infused |
|---|---|---|---|---|---|
| | Fabric | Phone- | with | with | with |
| Surface | (CF) | book | ReoFlex-60 | PDMS | Elastosil |
| Average | 21317 ± | 5515 ± | 478 ± | 211 ± | 2037 ± |
| Roughness | 301 nm | 992 nm | 341 nm | 25 nm | 172 nm |
| Rₐ | | | | | |

As illustrated in Table 1, carbon fabric can have an average roughness in the order of 20 μm. When infused with an elastomer (e.g., PDMS), the average roughness can be reduced to the order of 200 nm. The elastomer on the surface, when compressed, can deform and increase the amount of contact area as well. Therefore, the elastomer-infused surface can have large surface contact at least due to its smooth surfaces and deformability.

Still referring to FIG. 1, in one aspect, the shear force resistance of a configurable composite article can increase when the overall overlapping area increases. In some embodiments, the shear force resistance of a configurable composite article can be approximately proportional to its overall overlapping area. An overall overlapping area can be, in one way, defined as the product of each individual overlapping area and the number of individual overlapping areas. For example, the overall overlapping area in the configurable composite article 100 illustrated in FIG. 1 can be the area of an individual overlapping area (i.e., area referenced by 140) times the number of individual overlapping areas (i.e., four—one between 110-1 and 110-2, one between 110-2 and 110-3, one between 110-3 and 110-4, and one between 110-4 and 110-5). In one exemplary embodiment, a configurable composite article with an 1741 cm² overall overlapping area can resist 456 kgf of tensile load along the longitude direction of its sheets. In another aspect, the article includes a shear force that is applied at an angle with respect to the fabric layers. In one or more embodiments, the compressive force is substantially perpendicular to the fabric layers, as is illustrated in FIG. 1. The shear force resistance of a configurable composite article can increase when the compressive force increases. In some embodiments, the shear force resistance of a configurable composite article can be approximately proportional to the compressive force exerted across the plurality of sheets.

As discussed above, adjacent ones of the plurality of sheets 110 only partially overlap so that there are non-overlapping region 150 at one or two ends of the configurable composite article. An external load can be coupled onto the end regions 150 to apply tensile force along the longitude direction of the plurality of sheets 110. In some embodiments, without pulling both ends of each sheet 110 at the same time, the shear force resistance (e.g., against sliding) between two adjacent sheets (in addition to the tensile strength of each individual sheet itself) can provide the tensile strength of the configurable composite article 100.

Still referring to FIG. 1, the overlapping area 140 and the non-overlapping area 150 can be adjusted to fit various needs. As discussed above, in general, the larger the overlapping area 140, the larger the overall overlapping area, the higher the tensile strength of the configurable composite article. In some embodiments, the plurality of sheets are interleaved in a way such that there is sufficient non-overlapping area for coupling to an external object (e.g., a clamp of a tensile strength tester). In some other embodiments, the non-overlapping area can be enforced so that it can provide tensile strength at least as strong as the shear force resistance provided by the overlapping areas 140.

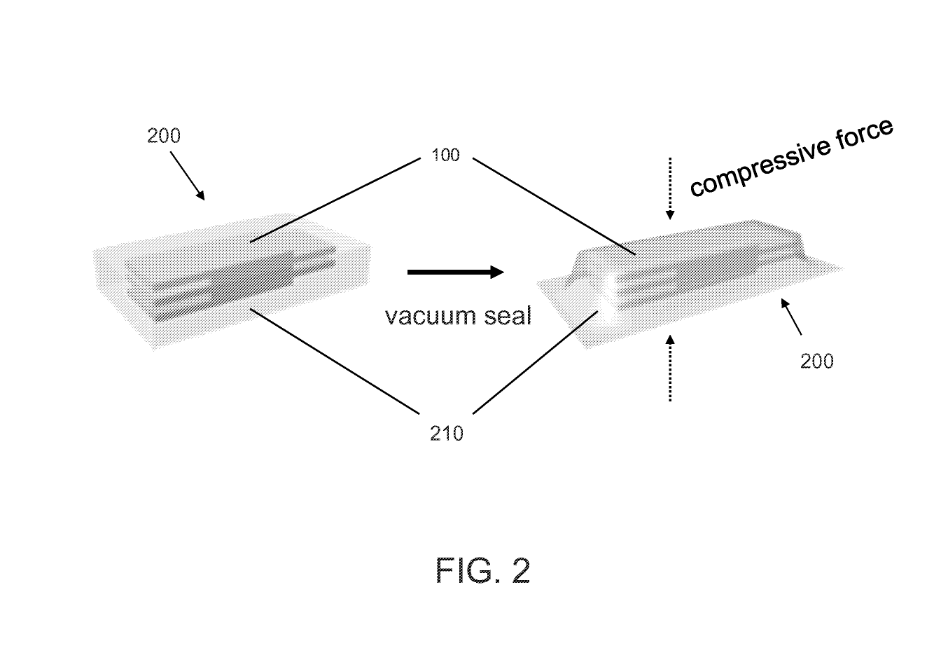

FIG. 2 illustrates perspective diagrams of an exemplary configurable composite article 200 according to some embodiments of the disclosed subject matter. The configurable composite arrangement 200 can include a configurable composite article 100 contained in a container 210. The container 210 can be deformable. In some embodiments, the container 210 can be deformed to fit an exterior profile of the configurable composite 100 contained within. Examples of the deformable container 210 include a bag (e.g., made of Nylon). In some embodiments, the deformable container 210 can be air tight. In some embodiments, air can be pumped out of the deformable container 210. The resulting difference between the external air pressure and the internal air pressure can provide a compressive force across the sheets of the configurable composite 100. In one example, the pressure difference between the exterior and interior of the container 210 can be around 950 millibar (mbar); for a configurable composite with an area of compressive force of around 600 cm², the 950 mbar pressure difference can yield a compressive force of around 584 kgf.

In some embodiments, the compressive force across the sheets of the configurable composite 100 can be generated by other mechanisms. In one embodiment, the compressive force can be generated using an electric field. For example, two separated plates can be oppositely charged (like a capacitor); the resulting Maxwell stress can exert compressive force upon the sheets. In another embodiments, each sheet is individually charged. Adjacent sheets can be charged oppositely, thus creating an ‘interleaved’ capacitor. In another embodiment, the compressive force can be generated using a magnetic field. For example, neighboring sheets can be magnetically polarized in the same direction; the magnetic interactions between the two neighboring sheets can exert compressive force upon the sheets. In yet another embodiment, the compressive force can be generated using a magnetic field. For example, strong magnets on the two opposite sides of a composite article can exert compressive force upon the sheets. In yet another embodiment, mechanical constraints, such as clamps, rubber bands, or plates screwed together, can be used to physically compress the sheets. In yet another embodiment, a pneumatic bladder can be wrapped around the sheets and inflated to compress the sheets.

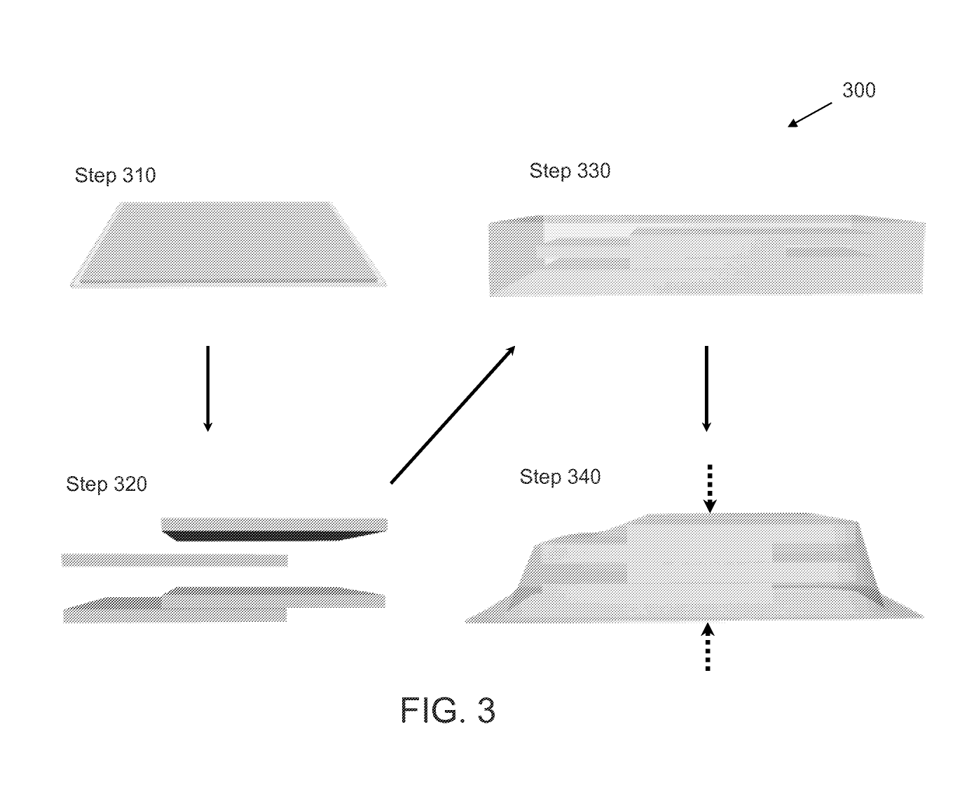

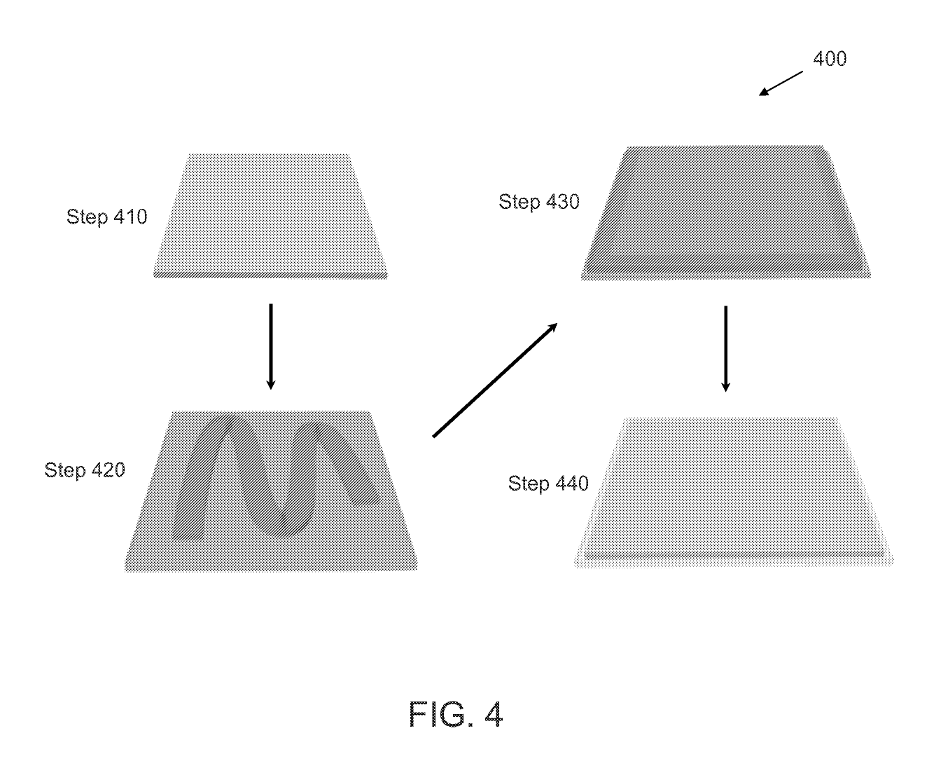

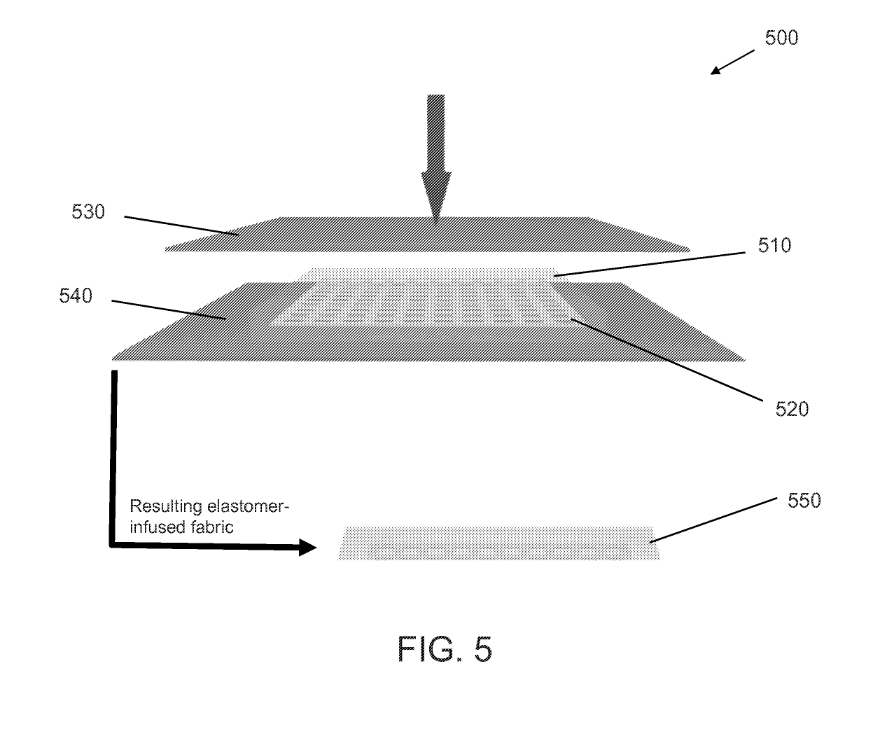

FIG. 3 illustrates an exemplary process 300 of preparing an exemplary configurable composite article according to some embodiments of the disclosed subject matter. One or more steps in the process 300 can be added, removed, or re-arranged in order. In step 310, a plurality of elastomer-infused sheets can be provided. Exemplary processes of preparing an elastomer-infused sheet are described in details later in conjunction with FIGS. 4 and 5. In step 320, the plurality of elastomer-infused sheets can be interleaved together. The plurality of elastomer-infused sheets only partially overlap with each other. In step 330, the interleaved plurality of elastomer-infused sheets can be positioned inside a container. In some embodiments, the container is deformable. In some embodiments, the container is air-tight. In step 340, air is pumped out from the deformable container. The air pressure difference between the inside and the outside of the deformable container can exert a compressive force across the plurality of elastomer-infused sheets.

FIG. 4 illustrates an exemplary process 400 of preparing an exemplary elastomer-infused sheet for constructing configurable composite articles according to some embodiments of the disclosed subject matter. One or more steps in the process 400 can be added, removed, or re-arranged in order. In step 410, a fabric sheet is provided. Examples of the fabric sheet can include carbon fabrics or papers. In step 420, an elastomer is applied onto a substrate with a smooth surface. Examples of the substrate with a smooth surface can include a glass plate. Examples of the elastomer can include PDMS and ReoFlex. The elastomer can be processed in various forms (e.g., liquid, gel, mix, etc.). In some embodiments, although the elastomer in the final composite can be a solid or a gel, the elastomer can be infused into the fabric sheet in an intermediary state (e.g., liquid or sol state). In step 430, the fabric sheet is placed on the smooth surface of the substrate with the elastomer. The fabric sheet can be pressed evenly against the smooth surface of the substrate so that the elastomer is evenly distributed and infused into the fabric sheet. In some embodiments, a roller can roll over the fabric sheet against the substrate. Additional elastomer can be applied and infused on the other side of the fabric sheet. In step 440, the elastomer infused in the fabric sheet can be cured (e.g., in high temperature for a certain period of time). The cured elastomer-infused fabric sheet can then be peeled off from the substrate. The process 400 can help form a smooth surface on the fabric sheet. In one exemplary embodiment, the average roughness Rₐ, of the original fabric sheet (e.g., in step 410) can be in the range of 50 μm while Rₐ of the elastomer-infused sheet (e.g., after step 440) can be in the range of 200 nm. More examples of surface roughness are listed in Table 1. The smooth surfaces can help ensure the fabric sheets are in close contact with the adjacent fabric sheets. Close contact between elastomer-infused fabric sheets can increase the effective contact surface area and thus increase the shear resistance of the configurable composites.

FIG. 5 illustrates another exemplary process 500 of preparing an exemplary elastomer-infused sheet for constructing configurable composite articles according to some embodiments of the disclosed subject matter. An elastomer sheet 510 can be placed over a fabric sheet 520 (e.g., a mesh). They can be placed between an upper plate 530 and a lower plate 540. At least one of the upper plate 530 and the lower plate 540 can be heated. The upper plate 530 and the lower plate 540 can have smooth surfaces. The upper plate 530 can be pressed against the lower plate 540, thus infusing the elastomer 510 into the fabric sheet 520, resulting an elastomer infused fabric, whose cross-sectional view is demonstrated in 550.

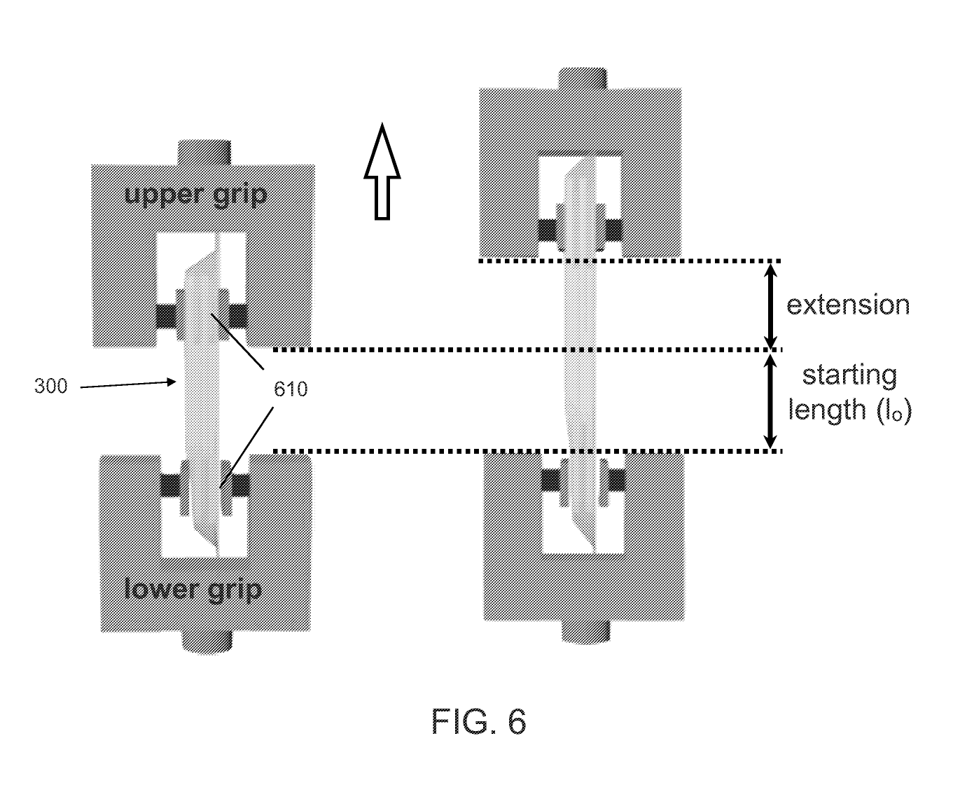

FIG. 6 illustrates an exemplary testing process for a configurable composite article 300 according to some embodiments of the disclosed subject matter. A configurable composite contained inside a vacuumed container 300 can undergo test for its tensile strength. An upper grip and a lower grip can be coupled to the two ends 610 of the configurable composite article. In some embodiments, adjacent sheets of the plurality of sheets are not overlapped at the two ends 610 for coupling. An expanded view of an end area where the adjacent sheets are not overlapped is also illustrated in FIG. 1 (e.g., 150). Referring back to FIG. 6, either one or both of the upper and lower grips can move away from each other, generating tension force on the configurable composite article 300. As the configurable composite article 300 is extended, the tensile force/load can be measured.

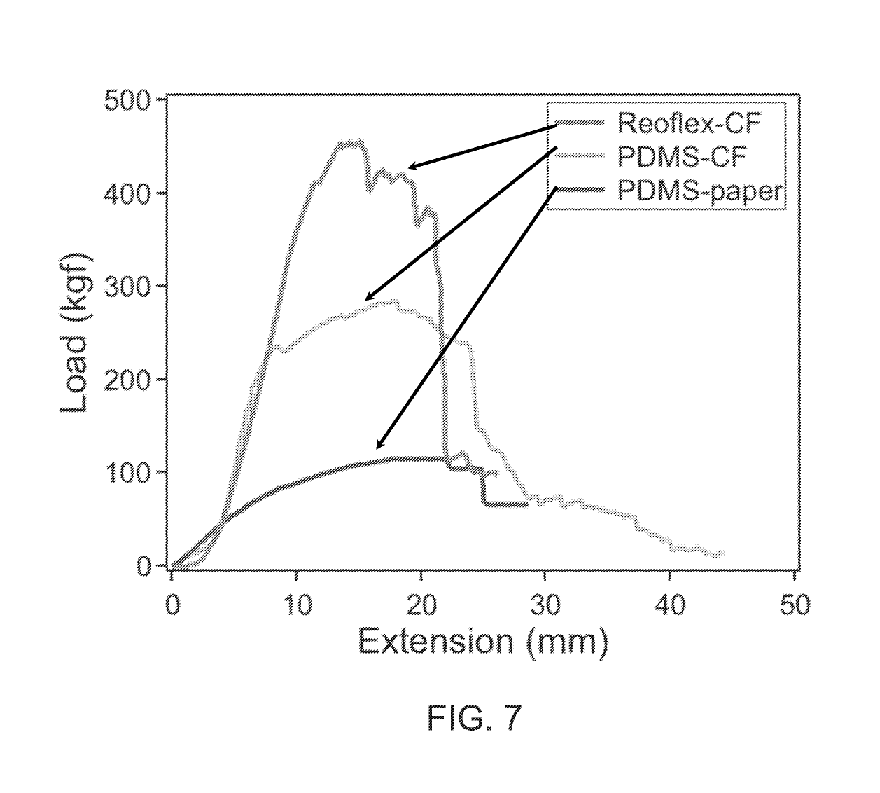

FIG. 7 illustrates mechanical properties of some exemplary configurable composite articles. As illustrated in FIG. 7, a configurable composite article formed with ReoFlex-infused carbon fabrics can sustain a maximum tensile load of around 450 kgf when it is extended for about 15 millimeter (mm); a configurable composite article formed with PDMS-infused carbon fabrics can sustain a maximum tensile load of around 280 kgf when it is extended for about 20 mm; a configurable composite article formed with PDMS-infused paper can sustain a maximum tensile load of around 100 kgf when it is extended for about 20 mm.

In another aspect of the disclosed subject matter, the shape of a configurable composite article can be adjusted to fit customized needs by altering the layouts of the individual interleaving sheets.

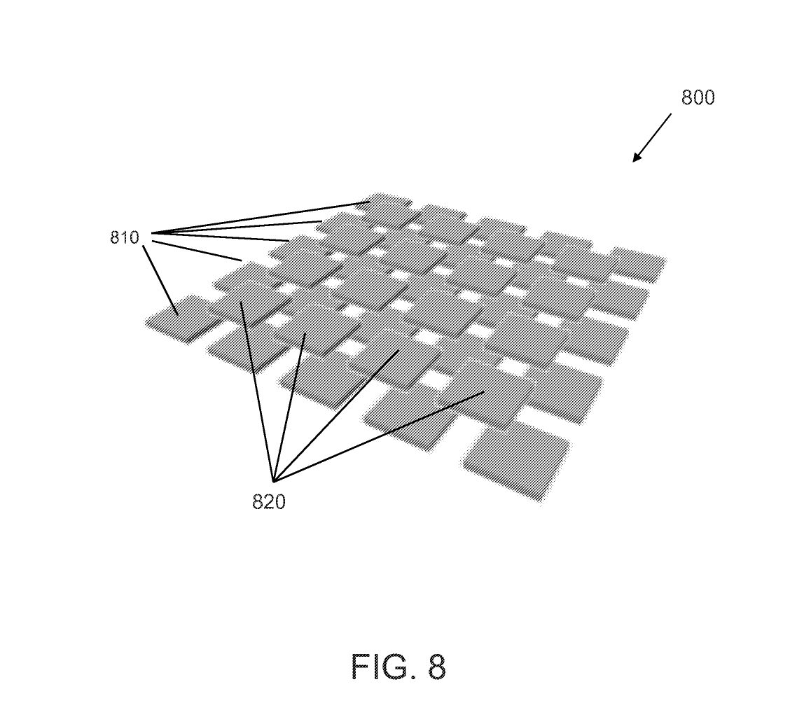

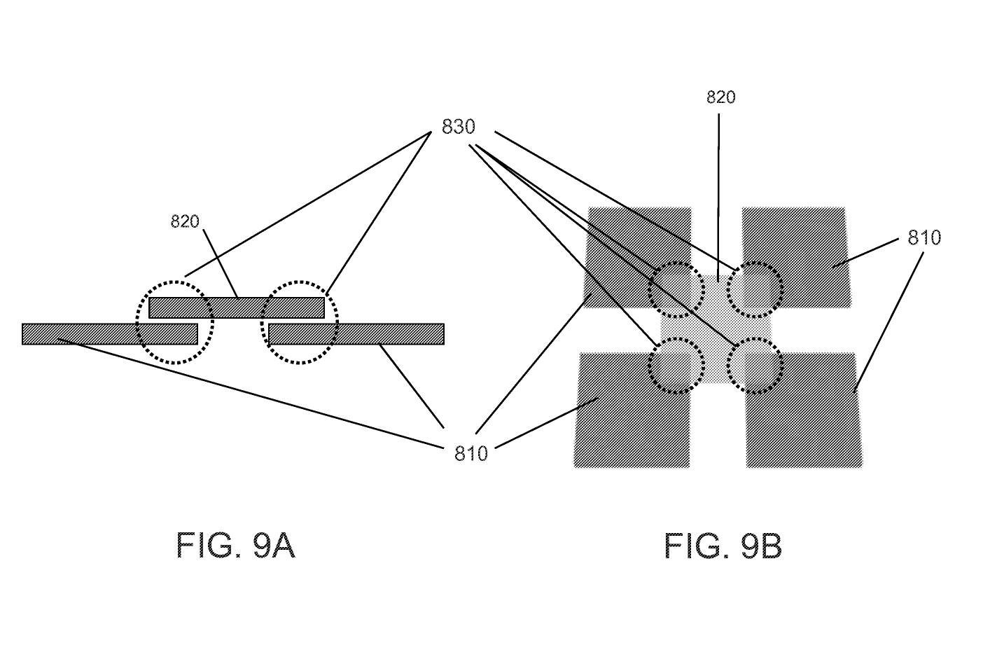

FIG. 8 illustrates a perspective view of another exemplary configurable composite article 800 according to some embodiments of the disclosed subject matter. The configurable composite article 800 can have a first plurality of tiles at a first layer (e.g., the bottom layer) and have a second plurality of titles at a second layer (e.g., the top layer). In some embodiments, each tile can be an elastomer-infused fabric sheet as discussed earlier in this document. In some embodiments, the tiles in each layer can be placed in a checkerboard pattern. For example, the tiles are in the shape of a 2 cm×2 cm square and are placed 1 cm apart from each other. FIG. 9A illustrates a cross-section diagram of contact surfaces in the exemplary configurable composite article 800. FIG. 9B illustrates a top-view diagram of contact surfaces in the exemplary configurable composite article 800. The first and second layers of tiles can be interleaved so that a tile 820 in one layer (e.g., the top layer) is partially overlapped with at least two tiles 810 in the other layer (e.g., the bottom layer). The overlapping areas 830 can bridge the tiles from the two layers.

The configurable composite article 800 can be placed inside a deformable container (not shown in FIG. 8). Examples of the deformable container can include an air-tight Nylon bag. When the air is pulled out of the deformable container, the air pressure between the inside and outside of the container can exert compressive force across the overlapping areas 830 of the first and second layers of tiles. The overlapping areas 830 when compressed can provide shear force resistance to the configurable composite article 800 as discussed earlier in this document. The overlapping area 830 can be adjusted to configure the physical and mechanical properties of the configurable composite 800. In some embodiments, increasing each overlapping area 830 and/or increasing the number of overlapping areas can increase the tensile strength of the configurable composite article 800; in the meantime, it can increase the rigidity and reduce the flexibility of the configurable composite article 800.

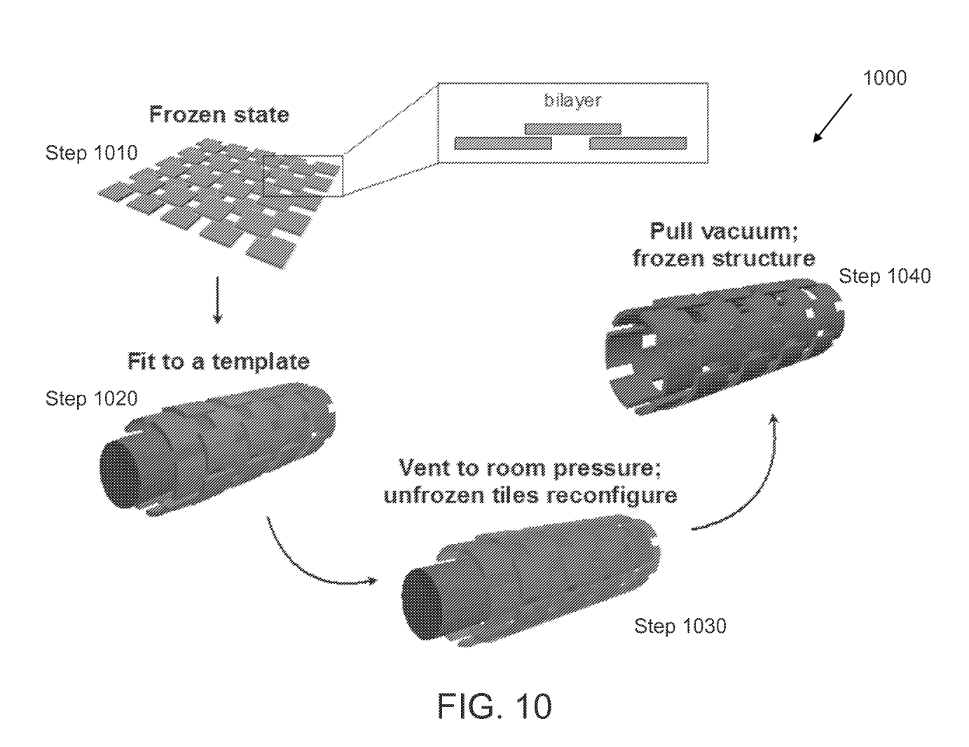

FIG. 10 illustrates an exemplary process 1000 of using the exemplary configurable composite article 800 according to some embodiments of the disclosed subject matter. One or more steps in the process 1000 can be added, removed, or re-arranged in order. In step 1010, the air can be pulled out of the deformable container enclosing the configurable composite article (e.g., 800 in FIG. 8). The compression force generated by the vacuum can “freeze” the two layers of tiles in place so that the tiles are largely immobile to each other. In step 1020, the “frozen” configurable composite article in the vacuum deformable container can be fit onto a template (e.g., a rod). The flexibility of the configurable composite article 800 can allow it to conform to a profile of the template. In step 1030, the deformable container can be vented to room air pressure. Loss of pressure difference can release the compression force across the configurable composite article 800, thus “unfreezing” the configurable composite article 800. The positions of two layers of “unfrozen” tiles, while still contained inside the deformable container, can then be adjusted so that they can better fit to the template. In step 1040, once the two layers of tiles in the configurable composite article 800 are adjusted to fit the template satisfactorily, the air can be pulled out of the deformable container again to “freeze” the two layers of tiles in place. Once the configurable composite article reaches its ideal shape and configuration, the template can be removed.

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

What is claimed is:

1. A composite article, comprising:
a plurality of sheets positioned to interleave and partially overlap with each other and held together by interactions between the plurality of sheets and a compressive force across the plurality of sheets,
wherein each of the plurality of sheets is infused with an elastomer and forms at least one smooth surface,
wherein each of the plurality of sheets is in close contact with adjacent ones of the plurality of sheets,
wherein an overlapping area of the plurality of sheets provides resistance to a shear force applied to the composite article.

2. The composite article of claim 1, wherein the plurality of sheets include fabric sheets.

3. The composite article of claim 1, wherein the plurality of sheets include at least one of carbon fabric sheets, metallic meshes, or papers.

4. The composite article of claim 1, wherein the elastomer contains polydimethylsiloxane (PDMS).

5. The composite article of claim 1, further comprising a deformable container enclosing the plurality of sheet, wherein the compressive force is generated by a pressure difference between the outside and inside of the deformable container.

6. The composite article of claim 5, wherein the deformable container is air tight.

7. The composite article of claim 5, wherein the compressive force is approximately 1 bar.

8. The composite article of claim 1, wherein the compressive force is generated by an electric field.

9. The composite article of claim 1, wherein the compressive force is generated by a magnetic field.

10. The composite article of claim 1, further comprising at least one end region coupled to an external coupling.

11. The composite article of claim 1, wherein the resistance to the shear force increases when the number of the plurality of sheets increases.

12. The composite article of claim 1, wherein the resistance to the shear force increases when the overlapping area increases.

13. The composite article of claim 1, wherein the at least one smooth surface has an average roughness Rₐ of about 200 nm.

14. A method of preparing a composite article, comprising:
providing a plurality of sheets;
infusing each of the plurality of sheets with an elastomer to form at least one smooth surface;
interleaving and partially overlapping the plurality of sheets with each other; and
applying a compressive force across the plurality of sheets, wherein each of the plurality of sheets is in close contact with adjacent ones of the plurality of sheets and wherein an overlapping area of the plurality of sheets provides resistance to a shear force applied to the composite article.

15. The method of claim 14, further comprising:
providing a substrate with a second smooth surface;
applying the elastomer on the second smooth surface of the substrate;
placing each of the plurality of sheets onto the second smooth surface of the substrate;
pressing the each of the plurality of sheets against the substrate to infuse the elastomer into the each of the plurality of sheets;
curing the elastomer infused in the each of the plurality of sheets; and
removing the each of the plurality of sheets from the substrate, wherein the at least one smooth surface is formed on the each of the plurality of the sheet.

16. The method of claim 14, wherein the plurality of sheets include fabric sheets.

17. The method of claim 14, wherein the plurality of sheets include at least one of carbon fabric sheets, metallic meshes, or papers.

18. The method of claim 14, wherein the elastomer contains polydimethylsiloxane (PDMS).

19. The method of claim 14, further comprising
placing the plurality of sheets inside a deformable container; and
lowering air pressure inside the deformable container, wherein the compressive force is generated by a pressure difference between the outside and inside of the deformable container.

20. The method of claim 19, wherein the compressive force is approximately 1 bar.

21. The method of claim 14, wherein the compressive force is generated by an electric field.

22. The method of claim 14, wherein the compressive force is generated by a magnetic field.

23. The method of claim 14, further comprising increasing the number of the plurality of sheets to increase the resistance to the shear force.

24. The method of claim 14, further comprising increasing the overlapping area to increase the resistance to the shear force.

25. The method of claim 14, wherein the at least one smooth surface has an average roughness Rₐ of about 200 nm.

26. A composite article, comprising:
a first plurality of tiles at a first layer; and
a second plurality of tiles at a second layer, positioned over the first layer,
wherein each of the first and second plurality of tiles is infused with an elastomer and forms at least one smooth surface,
wherein each of the second plurality of tiles at the second layer partially overlaps with and bridges at least two of the first plurality of tiles at the first layer,
wherein the first and second plurality of tiles are held together by interactions among the first and second plurality of tiles and a compressive force across the first and second plurality of tiles and remain immobile to each other,
wherein an overlapping area of the first and second plurality of tiles provides resistance to a shear force applied to the composite article.

27. The composite article of claim 26, wherein the first and second plurality of tiles become mobile to each other when the compressive force is relieved.

28. The composite article of claim 26, wherein the first and second plurality of tiles include fabric-based tiles.

29. A method of preparing a configurable composite article, comprising:
preparing a first plurality of tiles at a first layer;
overlaying a second plurality of tiles at a second layer on top of the first layer, wherein each of the second plurality of tiles partially overlaps with and bridges at least two of the first plurality of tiles;
applying a compressive force across the first and second pluralities of tiles so that the first and second pluralities of tiles are in close contact and immobile to each other;
fitting the first and second pluralities of tiles to a profile of an object;
relieving the compressive force so that the first and second pluralities of tiles become mobile to each other;
rearranging the first and second pluralities of tiles to conform with the profile of the object; and
applying a second compressive force across the first and second pluralities of tiles so that the first and second pluralities of fabric tiles are again in close contact and immobile to each other.

30. The method of claim 29, wherein the first and second plurality of tiles include fabric-based tiles.
